(19) United States
(12) Patent Application Publication
(10) Pub. No.: US 2003/0135545 A1
(43) Pub. Date: Jul. 17, 2003

(54) Method for permitting reproduction of content file and recorded medium on which reproduction software for reproducing content file is recorded

(76) Inventors: Bunichiroh Fujii, Chiba (JP); Akira Matsubara, Tokyo (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/088,488

(22) PCT Filed: Jul. 30, 2001
(86) PCT No.: PCT/JP01/06535

(30) Foreign Application Priority Data
Jul. 28, 2000 (JP) 2000-229878

(51) Int. Cl. G06F 15/16; G06F 15/177

(52) U.S. Cl. 709/203; 709/222

(57) ABSTRACT

Problem: When a contents file is acquired and played back by play back software so that the contents of the contents file are enjoyed, it is not preferable that the contents file be copied among terminal users without any restriction from the view point of a copy right.

Solving means: When playback software for playing back a contents file is set up, a client ID inherent to each play back software is given and incorporated in the play back software as well as when the contents file is down loaded to a terminal computer, the client ID is incorporated also in the contents file, and the play back of the contents file is permitted only when the client IDs of both of the play back software and the contents file agree with each other.

### TECHNICAL FIELD

The present invention relates to a method of permitting the play back of a contents file down loaded from a server to a terminal computer and to a recording medium having recorded play back software for playing back the contents file.

### BACKGROUND ART

There are available audio data files of, for example, a WAV format and a MP3 format as contents files. To enjoy music by playing back an audio data file, play back software for playing back the audio data file is necessary separately. That is, when it is desired to enjoy contents files by playing back them, it is necessary to install play back software according to each type of contents files on a computer and then to get a favorite contents file and to play back it by the play back software.

When play back software is installed on a computer once, it can be used as it is for a long period of time in many cases even if an upgraded version of the software is released. In contrast, while a user may have only one contents file, when the user plays back it repeatedly, he or she gets tired of it. To cope with this problem, suppliers of contents files create many types of contents files so that operators of terminal computers, who are users of contents files, select favorite contents files from the many contents files and sequentially store them in their terminal computers.

In particular, with the recent rapid popularization of communication executed through the Internet communication network, many users access servers, in which contents files are stored, from terminal computers through the Internet communication network and down load contents files stored therein to the terminal computers.

The contents files include pay contents files and free contents files. However, when a contents file is down loaded once from a server to a terminal computer, it is possible to copy the contents file from the terminal computer to which it was down loaded to other terminal computer and to play back the copied contents file through play back software installed on the other terminal computer. Since the contents files are protected by a copy right, it is not preferable that the contents files be copied without any restriction in the circumstances where the creators of the contents files have nothing to do therewith, even if they are free contents files. Further, it is also not preferable to permit the unauthorized copies of the pay contents files because the users of them are treated unequally thereby in money.

In view of the above problems, it is an object of the present invention to provide a contents file play back permission method of preventing contents files from being copied without permission and from being played back by unspecified terminal computers and to provide a recording medium having recorded play back software for playing back the contents files.

### DISCLOSURE OF THE INVENTION

To solve the above problems, in a contents file play back permission method according to the present invention that permits a contents file, which has been down loaded from a server to a terminal computer connected to the server through a communication network, to be played back by the play back software installed on the terminal computer, the contents file play back permission method is characterized in that both the play back software and the contents file can incorporate client IDs; the play back software is set such that it permits the play back of the contents file only when the client ID thereof agrees with the client ID incorporated in the contents file; when profile data is transmitted from the terminal computer to the server at the time the play back software is set up, the server transmits a client ID inherent to each play back software to the terminal computer through the communication network so that the client ID is incorporated in the play back software; and, thereafter, when the terminal computer accesses the server, down loads the contents file and stores it therein, the server incorporates the client ID of the destination, to which the contents file is down loaded, in the contents file.

To connect the terminal computer to the server after the play back software has been installed thereon, the play back software is set such that it acquires the client ID and incorporates it therein. When the play back software is set up to acquire the client ID, profile data as to the operator of the terminal computer is stored in the server in relation to the client ID. In contrast, when the terminal computer down loads and stores the contents file thereafter, the client ID is incorporated in the contents file, and the contents file is stored in the terminal computer in the state in which the client ID is incorporated in the contents file. The play back software is set such that it permits the play back of the contents file only when the client ID thereof agrees with the client ID incorporated in the contents file. Thus, even if the contents file is copied in other terminal computer, the other terminal computer cannot play back the copied contents file because the client ID incorporated in the play back software thereof does not agree with the client ID incorporated in the copied contents file. As a result, the down loaded contents file can be prevented from being copied without permission.

Note that when the terminal computer accesses the server to down load a contents file, if the server acquires the client ID incorporated in the play back software of the terminal computer having accessed it, it is possible for the server to provide such a service that it picks up the contents files, which the server recommends based on the profile data related to the client ID, and causes a screen for selecting a contents file from the recommended ones to be displayed first. Further, the server can acquire data indicating that which contents file is down loaded to the terminal computer of which client ID.

Incidentally, in the case of pay contents files, it is necessary that pay members as well as operators who paid a fee only can down load the pay contents files. It cannot be discriminated from the client ID given to play back software whether or not a user is any one of a pay member and a user who paid a fee. It can be discriminated from an user ID whether or not the user is the pay member, and the like. Accordingly, both play back software and a contents file can incorporate user IDs, in addition to the client IDs, and it is sufficient for the play back software to be set such that it permits the play back of a contents file only when the client ID and user ID thereof agree with the client ID and user ID of the contents file.

When the user ID is used together with the client ID, it is possible to cause a relatively large contents file to be securely stored in terminal computers and then to permit the play back of the contents file in such a manner that a contents file, in which no user ID is incorporated, is distributed as, for example, a CD ROM or the like or is down loaded and then only the pay members are permitted to incorporate their user IDs in the contents file.

Further, in a recording medium according to the present invention that has recorded play back software installed on a terminal computer connected to a server through a communication network and which plays back a contents file down loaded from the server, the recording medium is characterized in that the play back software incorporates a client ID previously transmitted from the server therein; when the contents file is down loaded, the play back software incorporates the client ID in the contents file before the contents file is played back; and when the play back software plays back the contents file, it compares the client ID incorporated therein with the client ID incorporated in the contents file and plays back the contents file only when both the client IDs agree with each other.

Both the play back software and the contents file may incorporate user IDs, in addition to the client IDs, and the play back software may permit the play back of the contents file only when the client ID and user ID thereof agree with the client ID and user ID incorporated in the contents file, respectively.

Further, when the contents file is not played back, the recording medium may display a function such as a clock, or the like other than the contents file; and when a cursor is put on the display of the function, the display may be changed to a display in a mode which is different depending upon whether or not a particular contents file is down loaded.

In working places, it may be desired that the play back of a contents file is not aware of by other persons. It cannot be aware of by the other persons that the contents file is started up when other function such as a watch, or the like is displayed in a state in which the contents file is started up but is not displayed. Further, whether or not a contents file is present can be confirmed only by checking the change of a display when a cursor is put thereon.

### BRIEF DESCRIPTION OF THE DRAWINGS

FIG. 1 is a view showing a network to which the present invention is applied;

FIG. 2 is a flowchart showing a setup sequence of play back software;

FIG. 3 is a conceptual view showing an arrangement of a contents file;

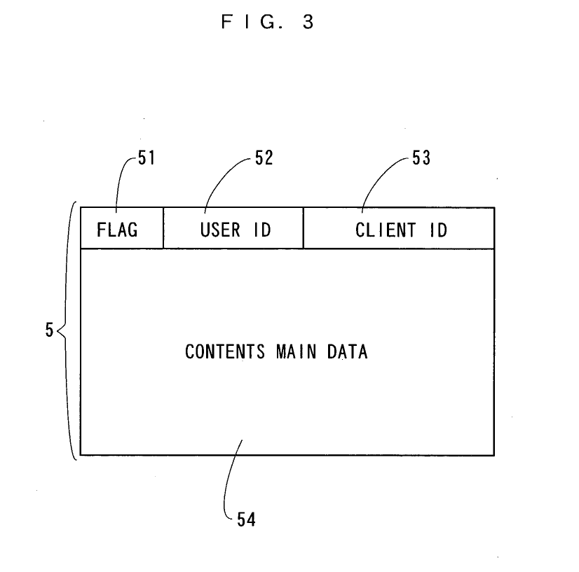

FIG. 4 is a view showing examples of the icon of the play back software;

FIG. 5 is a view showing an example of the icon when a contents file is played back; and

FIG. 6 shows time charts showing contents played back from a contents file.

### BEST MODE OF CARRYING OUT THE INVENTION

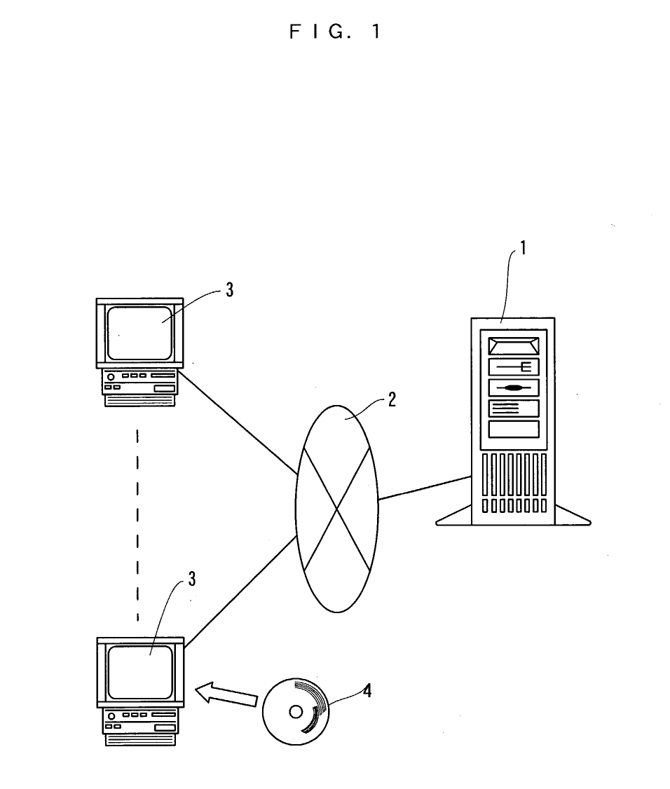

With reference to FIG. 1, reference numeral 1 denotes a server to which to a plurality of terminal computers 3 are connected through the Internet communication network 2. Play back software is installed on the respective terminal computers 3. The play back software is recorded on a recoding medium 4 such as a CDROM, a DVD, and the like which is distributed as a supplement, or the like appended to a magazine. Thus, the play back software is installed from the recoding medium 4, while it may be down loaded from the server 1 through the Internet communication network 2. The play back software does not work only when it is installed, and it must be set up without fail.

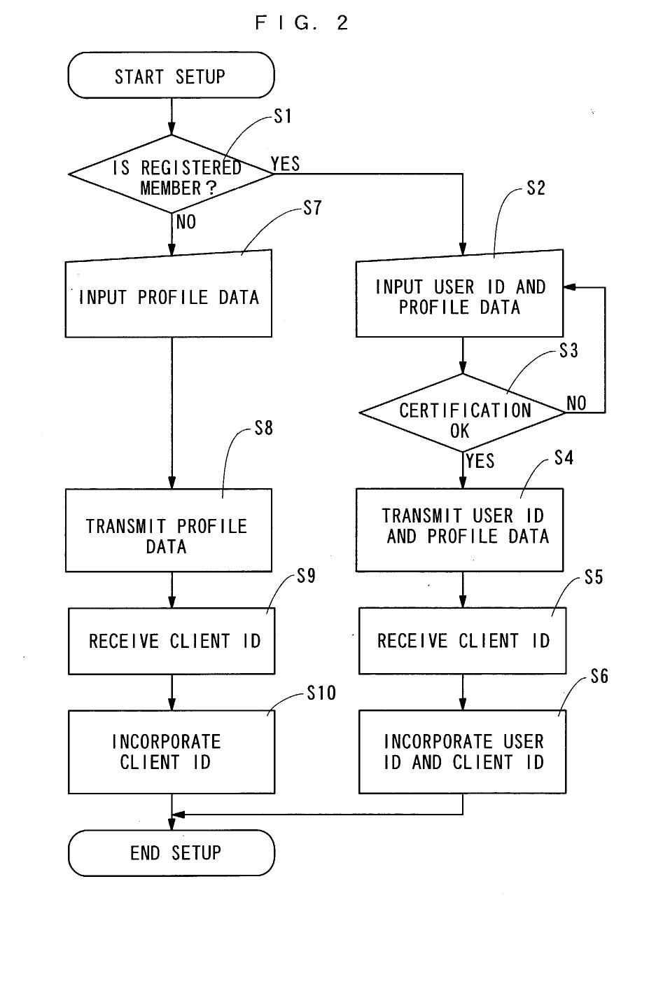

Referring to FIG. 2, when the setup of the play back software starts, first, it is selected whether or not a user of the software is a registered member (S1). The registered member means a member registered to an organization which operates the server 1. The registered member is authorized to down load not only free contents files but also pay contents files of the various kinds of the contents files stored in the server 1. In contrast, a user, who is not a member but has installed the play back software, is authorized to down load only the free contents files.

When a registered member sets up the play back software, he or she inputs a user ID, which was given to him or her at the time of member registration, and his or her profile data to a terminal computers 3 (S2). While data items required to the profile data may be set according to need, it is contemplated that they include, for example, sexuality, age, occupation, place of installation of the terminal computer 3, and so on. On the completion of input of data for these items, the terminal computer 3 is connected to the server through the Internet communication network 2, and the certification of the user ID is performed (S3). When the user fails to get the certification, he or she must return to step 2 and input the user ID and profile data again. Whereas, when the user succeeds to get the certification, the user ID and the profile data are automatically transmitted to the server 1. When the server 1 receives the user ID and the profile data, it transmits a client ID inherent (unique) to the terminal computer 3 from which the data was transmitted, and the terminal computer 3 receives the client ID (S5). The play back software installed on the terminal computer 3 having received the client ID incorporates the client ID and the user ID in the play back software at the predetermined sections thereof (S6), thereby the setup is completed.

In contrast, the user, who is not a registered member, inputs only profile data (S7) because he or she is not provided with a user ID. Thus, the terminal computer 3 automatically transmits the profile data to the server 1 (S8) and receives a client ID from the server 1 (S9). Then, the user incorporates the received client ID in the play back software installed on the terminal computer 3 having received the client ID (S10), thereby the setup is completed.

Note that the play back software is programmed such that all the jobs, which are subsequent to the query whether or not member registration is performed (S1), the request for input of user ID and client ID (S2 and S7) and the input of user ID and client ID (S2 and S7), are executed automatically. Thus, when the play back software is installed on the terminal computer 3, the jobs up to the completion of setup is automatically carried out.

When the setup is completed as described above, it is possible for the user to access the server 1 from the terminal computer 3, to down load a desired contents file from the various kinds of the contents files stored in the server 1, and to play back it through the play back software. However, the contents files include the pay contents files the play back of which is permitted only to members and the free contents files the play back of which is permitted also to persons other than the members.

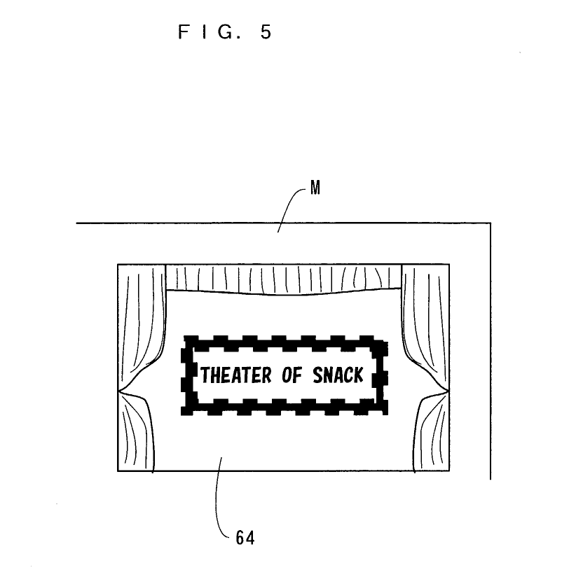

Each contents file has a structure conceptually shown in FIG. 5. That is, each contents file has an incorporating section 51 in which a flag is incorporated which indicates whether the contents file is pay or free, an incorporating section 52 in which an user ID is incorporated, and an incorporating section 53 in which a client ID is incorporated, and these sections are preset in the file. No data is incorporated in the user ID incorporating section 52 and in the client ID incorporating section 53 at the time each contents file is stored in the server 1, while the flag for indicating whether it is pay or free is incorporated in the incorporating section 51. Note that contents main data is incorporated in a section 54 other than these incorporating sections.

When a user down loads a free contents file, the play back software incorporates the client ID of the user, which was incorporated in the setup, in the incorporating section 53 of the contents file at once. At that time, the play back software confirms the flag in the incorporating section 51, and when the contents file is free, the play back software need not incorporate any data in the user ID incorporating section 52. However, when the user is a pay member, the play back software may incorporate his or her user ID in the incorporating section 52, whereas when the user is other than the pay member, the play back software may incorporate a tentative user ID indicating that the user is not a pay member. Alternatively, the play back software may incorporate a dummy ID data equally. The play back software plays back the down loaded contents file only when the client ID incorporated in the play back software agrees with the client ID incorporated in the incorporating section 53 of the contents file in the comparison thereof. With this arrangement, a free contents file can be played back by a terminal computer that down loaded it. However, even if it is indented to play back the down loaded free contents file by a terminal computer other than the terminal computer that down loaded it, the free contents file cannot be played back thereby because the client ID of the terminal computer does not agree with that of the down loaded free contents file.

The down load of a pay contents file may be prohibited unless a user ID is input and certified at the time it is down loaded. However, the down load itself of a play contents file may be permitted freely to any person, or it may be circulated as a medium such as a CD ROM or the like free of charge. However, when the flag in the incorporating section 51 of the pay contents file indicates that the file is pay, the play back software does not play back the file unless the user IDs of both of them agree with each other, in addition to the agreement off the client IDs thereof. When a pay contents file is down loaded or installed from a medium to the hard disc or the like of the terminal computer 3, the play back software immediately incorporates the client ID in the incorporating section 53 of the file, similarly to the case of a free contents file, but the play back software incorporates no data in the incorporating section 52 of the file. When a user is a registered member, the play back software incorporates his or her user ID in the incorporating section 52 at the time he or she accesses the server 1 and gets certification. After the user ID has been incorporated in the incorporating section 52, the contents file can be played back by the play back software. Even if a user, who is not a registered member, down loads a pay contents file, the pay contents file cannot be played back because he or she cannot incorporate a user ID in the incorporating section 52 of the file and no user ID is incorporated in play back software.

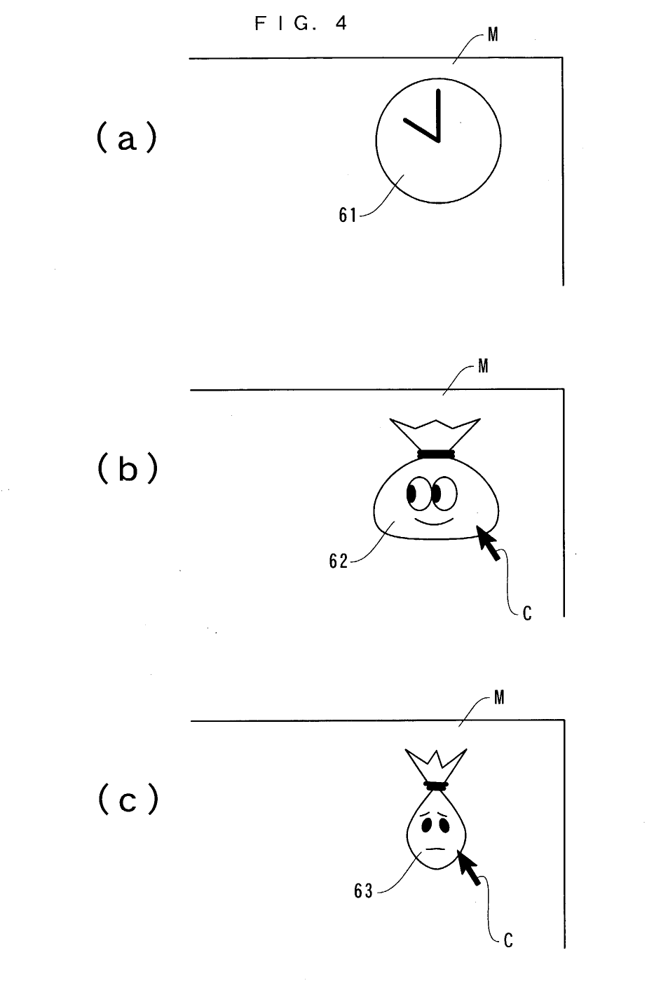

While some contents files contain music, still pictures, moving pictures, and the like independently recorded therein, there are also contents files which contain them in a composite mode. FIG. 4 shows an example of play back software for playing back these contents files. When the play back software shown in the figure has been set up according to the flow shown in FIG. 2, the play back software usually displays, for example, a clock icon 61 at the right corner of the screen M of the terminal computer 3. A daily contents file that is updated everyday is prepared in the server 1, in addition to the pay contents files and the free contents files. The terminal computer 3 may down load the daily contents file by automatically accessing the server 1 or an operator may manually down load it. In any case, when the operator puts a cursor C on the clock icon 61 at the time the daily contents file has been down loaded in the terminal computer 3, the clock icon 61 is changed to an icon 62 shown in FIG. 4(b) during the period of time the cursor C is being put on the clock icon 61. In contrast, the cursor C is put on the clock icon 61 at the time the daily contents file is not down loaded or has been automatically deleted, the clock icon 61 is changed to an icon 63 shown in FIG. 4(c). When the daily contents file has been down loaded, the play back software automatically plays back it when a predetermined time arrives (for example, 3 p.m.). Since the daily contents file is free, the play back software plays back it only when a client ID incorporated in the daily contents file agrees with the client ID incorporated in the play back software in the comparison thereof. When the daily contents file is played back, the clock icon 61 changes to an icon 64 which imitates, for example, a stage of a theater as shown in FIG. 5. Then, a predetermined enjoyable or relaxing moving picture and music are played back for a predetermined period of time.

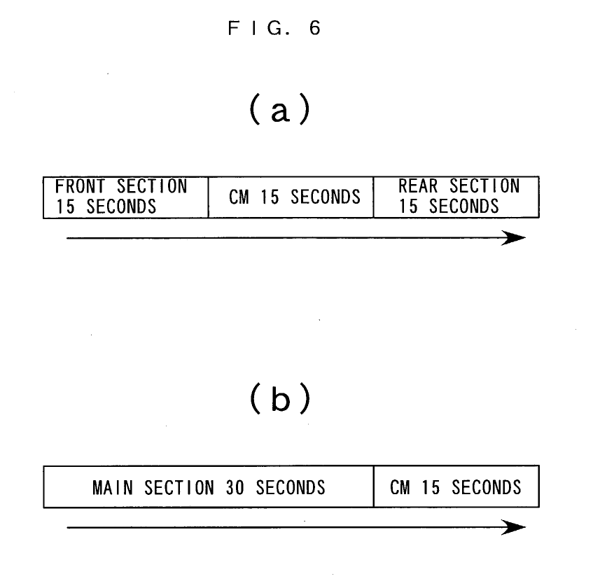

When the contents to be played back take 45 seconds in their entirety, a commercial message of 15 seconds may be sandwiched between the front section of the contents and the rear section thereof each taking 15 seconds, as shown in FIG. 6(a). Alternately, a commercial message of 15 seconds may be played back after the main section of the contents is played back for 30 seconds, as shown in FIG. 6(b). Incidentally, if the server 1 reads the client ID on the terminal computer 3 side first at the time the daily contents file is down loaded to the terminal computer 3, it is possible to down load the contents of the daily contents file, which seem most suitable to the profile data corresponding to the client ID, referring to the profile data. A plurality of the daily contents files may be prepared, or the section of the commercial message may be replaced with other one. When it is found that a user is interested in, for example, a car, a previous commercial message may be replaced with a commercial message of a new car, and when the user is fond of tourism, it may replaced with a commercial message of a travel agent.

When the daily contents file is played back, the play back software automatically deletes it after it has been played back. Note that an entertainment section other than a commercial message can be stored in the server 1 as a free or pay contents file, can be down loaded to the terminal computer 3, and can be played back by the play back software.

Industrial Applicability

As apparent from the above description, in the present invention, both play back software and a contents file have client IDs incorporated therein, and the play back software is permitted to play back the contents file only when the client ID of the play back software agrees with that of the contents file. Accordingly, it is impossible for the play back software of other computers to play back the contents file. As a result, the copy of the content file can be prevented.

1. A contents file play back permission method of permitting a contents file, which has been down loaded from a server to a terminal computer connected to the server through a communication network, to be played back by the play back software installed on the terminal computer, characterized in that both the play back software and the contents file can incorporate client IDs; the play back software is set such that it permits the play back of the contents file only when the client ID thereof agrees with the client ID incorporated in the contents file; when profile data is transmitted from the terminal computer to the server at the time the play back software is set up, the server transmits a client ID inherent to each play back software to the terminal computer through the communication network so that the client ID is incorporated in the play back software; and, thereafter, when the terminal computer accesses the server, down loads the contents file and stores it therein, the server incorporates the client ID of the destination, to which the contents file is down loaded, in the contents file.

2. A contents file play back permission method according to claim 1, characterized in that when the terminal computer accesses the server to down load the contents file, the server acquires the client ID incorporated in play back software of the terminal computer having accessed the server.

3. A contents file play back permission method according to claim 1 or 2, characterized in that both the play back software and the contents file can incorporate user IDs, in addition to the client IDs, and the play back software is set such that it permits the play back of the contents file only when the client ID and user ID thereof agree with the client ID and user ID incorporated in the contents file, respectively.

4. A recording medium that has recorded play back software installed on a terminal computer connected to a server through a communication network and which plays back a contents file down loaded from the server, characterized in that the play back software incorporates a client ID previously transmitted from the server therein; when the contents file is down loaded, the play back software incorporates the client ID in the contents file before the contents file is played back; and when the play back software plays back the contents file, it compares the client ID incorporated therein with the client ID incorporated in the contents file and plays back the contents file only when, both the client IDs agree with each other.

5. A recording medium that has recorded play back software for playing back a contents file according to claim 4, characterized in that both the play back software and the contents file can incorporate user IDs, in addition to the client IDs, and the play back software permits the play back of the contents file only when the client ID and the user ID thereof agree with the client ID and the user ID incorporated in the contents file, respectively.

6. A recording medium that has recorded play back software for playing back a contents file according to claim 4 or 5, characterized in that when the contents file is not played back, the recording medium displays a function such as a clock, or the like other than the contents file; and when a cursor is put on the display of the function, the display is changed to a display in a mode which is different depending upon whether or not a particular contents file is down loaded.
